(19) United States
(12) Patent Application Publication
(10) Pub. No.: US 2024/0405425 A1
(43) Pub. Date: Dec. 5, 2024

(54) ANTENNA-IN-MODULE AND ASSOCIATED METHOD WITH IMPROVED PERFORMANCES

(71) Applicant: MEDIATEK Inc., Hsinchu City (TW)

(72) Inventors: Wei-Hsuan CHANG, Hsinchu City (TW); Chih-Wei CHIU, Hsinchu City (TW); Yeh-Chun KAO, Hsinchu City (TW); Chih-Wei LEE, Hsinchu City (TW)

(21) Appl. No.: 18/328,144

(22) Filed: Jun. 2, 2023

(51) Int. Cl. H01Q 3/36; H01Q 3/26

(52) U.S. Cl. CPC H01Q 3/36; H01Q 3/2611; H01Q 3/2694

(57) ABSTRACT

The invention provides an antenna-in-module (AiM) and related method with improved performances. The AiM may comprise a plurality of radiators, port-one terminals and port-two terminals; the port-one and port-two terminals may be coupled to the radiators respectively. The AIM may implement a mode-one wireless communication by excitations of a plurality of phase-shifted versions of a mode-one signal respectively at the plurality of port-one terminals, may implement a mode-two wireless communication by excitations of a plurality of phase-shifted versions of a mode-two signal respectively at the plurality of port-two terminals, and may implement a mode-three wireless communication by simultaneous excitations of a first plurality and a second plurality of phase-shifted versions of a mode-three signal respectively at the plurality of port-one terminals and the plurality of port-two terminals. Polarizations of the mode-one, mode-two and the mode-three wireless communications may be different.

### FIELD OF THE INVENTION

The present invention relates to an antenna-in-module (AiM) and associated method with improved performances, and more particularly, to an AiM and associated method regarding an AiM which may comprise a plurality of radiators, a plurality of port-one terminals respectively coupled to the radiators, and a plurality of port-two terminals also respectively coupled to the radiators; wherein the AiM may implement a mode-one wireless communication by excitations at the port-one terminals, may implement a mode-two wireless communication by excitations at the port-two terminals, may further implement one or more additional modes of wireless communications by simultaneous excitations at the port-one and port-two terminals; the AiM may improve performances by implementing the more than two modes of wireless communications, with polarizations of the modes of wireless communications being different.

### BACKGROUND OF THE INVENTION

As more contemporary electronic devices require functionality of wireless communication, how to improve performances of wireless communication is of key importance.

### SUMMARY OF THE INVENTION

An object of the invention is providing an antenna-in-module (AiM) with improved performances. The AiM (e.g., 100 in FIGS. 1a and 1b) may comprise a plurality of radiators (e.g., r[1] to r[N] in FIG. 1a or 1b), a plurality of port-one terminals (e.g., V[1] to V[N] in FIG. 1a or 1b) and a plurality of port-two terminals (e.g., H[1] to H[N] in FIG. 1a or 1b). The plurality of port-one terminals may be respectively coupled to the plurality of radiators, and the plurality of port-two terminals may also be respectively coupled to the plurality of radiators. The AiM may implement a mode-one (e.g., m[1]) wireless communication by excitations of a plurality of phase-shifted versions (e.g., sV[1]_m[1]_b[k] to sV[N]_m[1]_b[k] in FIG. 2a) of a mode-one signal (e.g., s2 or s3 in FIG. 1c) respectively at the plurality of port-one terminals. The AiM may further implement a mode-two (e.g., m[2]) wireless communication by excitations of a plurality of phase-shifted versions (e.g., sH[1]_m[2]_b[k] to sH[N]_m[2]_b[k] in FIG. 2b) of a mode-two signal (e.g., s2 or s3 in FIG. 1c) respectively at the plurality of port-two terminals. In addition, the AiM may further implement a mode-three (e.g., m[3] or m[4]) wireless communication by simultaneous excitations of a first plurality (e.g., sV[1]_m[3]_b[k] to sV[N]_m[3]_b[k] in FIG. 2c or sV[1]_m[4]_b[k] to sV[N]_m[4]_b[k] in FIG. 2d) and a second plurality (e.g., sH[1]_m[3]_b[k] to sH[N]_m[3]_b[k] in FIG. 2c or sH[1]_m[4]_b[k] to sH[N]_m[4]_b[k] in FIG. 2d) of phase-shifted versions of a mode-three signal (e.g., s2 or s3 in FIG. 1c) respectively at the plurality of port-one terminals and the plurality of port-two terminals. Polarizations of the mode-one, mode-two and mode-three wireless communications may be different.

In an embodiment (e.g., FIG. 2c), the polarizations of the mode-one, the mode-two and the mode-three wireless communications may be parallel to a mode-one, a mode-two and a mode-three vectors (e.g., um[1], um[2] and um[3] in FIG. 2c) respectively, wherein the mode-one, mode-two and mode-three vectors may be nonparallel.

In an embodiment (e.g., FIG. 2c), the mode-three vector may not be perpendicular to the mode-one and mode-two vectors.

In an embodiment (e.g., FIG. 2c), the mode-three vector may be parallel to a sum of the mode-one and mode-two vectors, or a difference between the mode-one and mode-two vectors.

In an embodiment (e.g., FIG. 2c), a first port-one terminal (e.g., V[n] in FIG. 2c) of the plurality of port-one terminals may be coupled to a first radiator (e.g., r[n] in FIG. 2c) of the plurality of radiators, and a first port-two terminal (e.g., H[n] in FIG. 2c) of the plurality of port-two terminals may be coupled to the first radiator. The first plurality of phase-shifted versions of the mode-three signal may include a first and a fifth phase-shifted versions (e.g., sV[n]_m[3]_b[k] and sV[n]_m[3]_b[k′], for k and k′ not equal) of the mode-three signal, and the second plurality of phase-shifted versions of the mode-three signal may include a second and a sixth phase-shifted versions (e.g., sH[n]_m[3]_b[k] and sH[n]_m[3]_b[k′]) of the mode-three signal. When the AiM implements the mode-three wireless communication, the first radiator may contribute to a first beam (e.g., b[k] in FIG. 1d) of the mode-three wireless communication by simultaneous excitations of the first and second phase-shifted versions (e.g., sV[n]_m[3]_b[k] and sH[n]_m[3]_b[k]) of the mode-three signal respectively at the first port-one terminal and the first port-two terminal, and may contribute to a second beam (e.g., b[k′] in FIG. 1d) of the mode-three wireless communication by simultaneous excitations of the fifth and sixth phase-shifted versions (e.g., sV[n]_m[3]_b[k′] and sH[n]_m[3]_b[k′]) of the mode-three signal respectively at the first port-one terminal and the first port-two terminal. Beam directions (e.g., ub[k] and ub[k′] in FIG. 1d) of the first and the second beams of the mode-three wireless communication may be substantially nonparallel. A phase difference (e.g., pV[n]_m[3]_b[k]-pH[n]_m[3]_b[k]) between the first and the second phase-shifted versions of the mode-three signal, and a phase difference (e.g., pV[n]_m[3]_b[k′]-pH[n]_m[3]_b[k′]) between the fifth and the sixth phase-shifted versions of the mode-three signal, may be substantially equal (e.g., be equal to (pV_m[3]-pH_m[3])).

In an embodiment (e.g., FIG. 2c), a first port-one terminal and a second port-one terminal (e.g., V[n] and V[n′], for n and n′ not equal) of the plurality of port-one terminals may be respectively coupled to a first radiator and a second radiator (e.g., r[n] and r[n′]) of the plurality of radiators, a first port-two terminal and a second port-two terminal (e.g., H[n] and H[n′]) of the plurality of port-two terminals may be respectively coupled to the first radiator and the second radiator. The first plurality of phase-shifted versions of the mode-three signal may include a first and a third phase-shifted versions (e.g., sV[n]_m[3]_b[k] and sV[n′]_m[3]_b[k]) of the mode-three signal, and the second plurality of phase-shifted versions of the mode-three signal may include a second and a fourth phase-shifted versions (e.g., sH[n]_m[3]_b[k] and sH[n′]_m[3]_b[k]) of the mode-three signal. When the AiM implements the mode-three wireless communication, the first radiator may contribute to a beam (e.g., b[k]) of the mode-three wireless communication by simultaneous excitations of the first and the second phase-shifted versions (e.g., sV[n]_m[3]_b[k] and sH[n]_m[3]_b[k]) of the mode-three signal respectively at the first port-one terminal and the first port-two terminal (e.g., V[n] and H[n]), and the second radiator may contribute to the beam of the mode-three wireless communication by simultaneous excitations of the third and the fourth phase-shifted versions (e.g., sV[n′]_m[3]_b[k] and sH[n′]_m[3]_b[k]) of the mode-three signal respectively at the second port-one terminal and the second port-two terminal (e.g., V[n′] and H[n′]). A phase difference (e.g., pV[n]_m[3]_b[k]-pH[n]_m[3]_b[k]) between the first and the second phase-shifted versions of the mode-three signal, and a phase difference (e.g., pV[n′]_m[3]_b[k]-pH[n′]_m[3]_b[k]) between the third and the fourth phase-shifted versions of the mode-three signal, may be substantially equal (e.g., be equal to (pV_m[3]-pH_m[3])).

In an embodiment (e.g., FIG. 2c), a phase difference (e.g., pV[n]_m[3]_b[k]-pV[n′]_m[3]_b[k]) between the first and the third phase-shifted versions (e.g., sV[n]_m[3]_b[k] and sV[n′]_m[3]_b[k]) of the mode-three signal, and a phase difference (e.g., pH[n]_m[3]_b[k]-pH[n′]_m[3]_b[k]) between the second and the fourth phase-shifted versions (e.g., sH[n]_m[3]_b[k] and sH[n′]_m[3]_b[k]) of the mode-three signal, may be substantially equal (e.g., be equal to (p_r[n]_b[k]-p_r[n′]_b[k]).

In an embodiment (e.g., FIG. 2d), the AiM may further implement a mode-four (e.g., m[4]) wireless communication by simultaneous excitations of a first plurality (e.g., sV[1]_m[4]_b[k] to sV[N]_m4_b[k] in FIG. 2d) and a second plurality (e.g., sH[1]_m[4]_b[k] to sH[N]_m[4]_b[k] in FIG. 2d) of phase-shifted versions of a mode-four signal (e.g., s2 or s3 in FIG. 1c) respectively at the plurality of port-one terminals and the plurality of port-two terminals. A polarization of the mode-four wireless communication may be different from the polarizations of the mode-one, the mode-two and the mode-three wireless communications.

In an embodiment (e.g., FIG. 2d), the polarizations of the mode-one, the mode-two, the mode-three and the mode-four wireless communications may be along a mode-one, a mode-two, a mode-three and a mode-four vectors (e.g., um[1], um[2], um[3] and um[4] in FIG. 2d) respectively; the mode-three vector may be parallel to a sum of the mode-one and mode-two vectors, and the mode-four vector may be parallel to a difference between the mode-one and mode-two vectors.

In an embodiment (e.g., FIGS. 2c and 2d), a first port-one terminal (e.g., V[n]) of the plurality of port-one terminals may be coupled to a first radiator (e.g., r[n]) of the plurality of radiators, a first port-two terminal (e.g., H[n]) of the plurality of port-two terminals may be coupled to the first radiator, the first plurality of phase-shifted versions of the mode-three signal may include a first phase-shifted version (e.g., sV[n]_m[3]_b[k] in FIG. 2c) of the mode-three signal, the second plurality of phase-shifted versions of the mode-three signal may include a second phase-shifted version (e.g., sH[n]_m[3]_b[k] in FIG. 2c) of the mode-three signal. The first plurality of phase-shifted versions of the mode-four signal may include a first phase-shifted version (e.g., sV[n]_m[4]_b[k] in FIG. 2d) of the mode-four signal, and the second plurality of phase-shifted versions of the mode-four signal may include a second phase-shifted version (e.g., sH[n]_m[4]_b[k] in FIG. 2d) of the mode-four signal.

When the AiM implements the mode-three wireless communication, the first radiator may contribute to a beam (e.g., b[k]) of the mode-three wireless communication by simultaneous excitations of the first and the second phase shifted versions of the mode-three signal respectively at the first port-one terminal and the first port-two terminal. When the AiM implements the mode-four wireless communication, the first radiator may contribute to a beam (e.g., b[k]) of the mode-four wireless communication by simultaneous excitations of the first and the second phase shifted versions of the mode-four signal respectively at the first port-one terminal and the first port-two terminal. A beam direction of the beam of the mode-three wireless communication, and a beam direction of the beam of the mode-four wireless communication, may be substantially parallel. A phase difference (e.g., pV[n]_m[3]_b[k]-pH[n]_m[3]_b[k]) between the first and the second phase-shifted versions of the mode-three signal, and a phase difference (e.g., pV[n]_m[4]_b[k]-pH[n]_m[4]_b[k]) between the first and the second phase-shifted versions of the mode-four signal, may be substantially different.

In an embodiment (e.g., FIGS. 2c and 2d), the phase difference (e.g., pV[n]_m[3]_b[k]-pH[n]_m[3]_b[k]) between the first and the second phase-shifted versions of the mode-three signal, and the phase difference (e.g., pV[n]_m[4]_b[k]-pH[n]_m[4]_b[k]) between the first and the second phase-shifted versions of the mode-four signal, may be substantially different by one-hundred and eighty degrees.

In an embodiment (e.g., FIGS. 2c and 2d), a first port-one terminal and a second port-one terminal (e.g., V[n] and V[n′]) of the plurality of port-one terminals may be respectively coupled to a first radiator and a second radiator (e.g., r[n] and r[n′]) of the plurality of radiators, a first port-two terminal and a second port-two terminal (e.g., H[n] and H[n′]) of the plurality of port-two terminals may be respectively coupled to the first radiator and the second radiator. The first plurality of phase-shifted versions of the mode-three signal may include a first and a third phase-shifted versions (e.g., sV[n]_m[3]_b[k] and sV[n′]_m[3]_b[k],) of the mode-three signal, and the second plurality of phase-shifted versions of the mode-three signal include a second and a fourth phase-shifted versions (e.g., sH[n]_m[3]_b[k] and sH[n′]_m[3]_b[k]) of the mode-three signal. The first plurality of phase-shifted versions of the mode-four signal may include a first and a third phase-shifted versions (e.g., sV[n]_m[4]_b[k] and sV[n′]_m[4]_b[k]) of the mode-four signal, and the second plurality of phase-shifted versions of the mode-four signal may include a second and a fourth phase-shifted versions (e.g., sH[n]_m[4]_b[k] and sH[n′]_m[4]_b[k]) of the mode-four signal. When the AiM implements the mode-three wireless communication, the first radiator may contributes to a beam (e.g., b[k]) of the mode-three wireless communication by simultaneous excitations of the first and the second phase shifted versions of the mode-three signal respectively at the first port-one terminal and the first port-two terminals, and the second radiator may contribute to the beam of the mode-three wireless communication by simultaneous excitations of the third and the fourth phase-shifted versions of the mode-three signal respectively at the second port-one and the second port-two terminals. When the AiM implements the mode-four wireless communication, the first radiator may contributes to a beam (e.g., b[k]) of the mode-four wireless communication by simultaneous excitations of the first and the second phase shifted versions of the mode-four signal respectively at the first port-one terminal and the first port-two terminals, and the second radiator may contribute to the beam of the mode-four wireless communication by simultaneous excitations of the third and the fourth phase-shifted versions of the mode-four signal respectively at the second port-one and the second port-two terminals. A beam direction of the beam of the mode-three wireless communication, and a beam direction of the beam of the mode-four wireless communication, may be substantially parallel. A phase difference (e.g., pV[n]_m[3]_b[k]-pV[n′]_m[3]_b[k]) between the first and the third phase-shifted versions of the mode-three signal, and a phase difference (e.g., pV[n]_m[4]_b[k]-pV[n′]_m[4]_b[k]) between the first and the third phase-shifted versions of the mode-four signal, may be substantially equal (e.g., be equal to p_r[n]_b[k]-p_r[n′]_b[k]). A phase difference (e.g., pH[n]_m[3]_b[k]-pH[n′]_m[3]_b[k]) between the second and the fourth phase-shifted versions of the mode-three signal, and a phase difference (e.g., pH[n]_m[4]_b[k]-pH[n′]_m[4]_b[k]) between the second and the fourth phase-shifted versions of the mode-four signal, may be substantially equal (e.g., be equal to p_r[n]_b[k]-p_r[n′]_b[k]).

In an embodiment (e.g., FIGS. 3a to 3c), the plurality of port-one terminals (e.g., V[1] to V[N] in FIG. 3a) may be arranged to respectively connect a plurality of path-one terminals (e.g., p1[1] to p1[N] in FIG. 3a) of a radiofrequency integrated circuit (RFIC, e.g., 30 in FIG. 3a), and to respectively connect a plurality of path-three terminals (e.g., p3[1] to p3[N] in FIG. 3a) of the RFIC. The plurality of port-two terminals (e.g., H[1] to H[N] in FIG. 3a) may be arranged to respectively connect a plurality of path-two terminals (e.g., p2[1] to p2[N] in FIG. 3a) of the RFIC, and to respectively connect a plurality of path-four terminals (e.g., p4[1] to p4[N] in FIG. 3a) of the RFIC. When the AiM implements the mode-one wireless communication (e.g., FIG. 3b), the plurality of port-one terminals may be further arranged to enable exchange of the plurality of phase-shifted versions (e.g., sV[1]_m[1]_b[k] to sV[N]_m[1]_b[k]) of the mode-one signal between the AiM and the RFIC respectively via the plurality of path-three terminals, and to disable signal exchange between the AiM and the RFIC via the plurality of path-one terminals. When the AiM implements the mode-two wireless communication (e.g., FIG. 3b), the plurality of port-two terminals may be further arranged to enable exchange of the plurality of phase-shifted versions (e.g., sH[1]_m[2]_b[k] to sH[N]_m[2]_b[k]) of the mode-two signal between the AiM and the RFIC respectively via the plurality of path-four terminals, and to disable signal exchange between the AiM and the RFIC via the plurality of path-two terminals. When the AiM implements the mode-three wireless communication (e.g., FIG. 3c), the plurality of port-one terminals may be further arranged to enable exchange of the first plurality of phase-shifted versions (e.g., sV[1]_m[3]_b[k] to sV[N]_m[3]_b[k]) of the mode-three signal between the AiM and the RFIC respectively via the plurality of path-one terminals, and to disable signal exchange between the AiM and the RFIC via the plurality of path-three terminals; the plurality of port-two terminals may be further arranged to enable exchange of the second plurality of phase-shifted versions (e.g., sH[1]_m[3]_b[k] to sH[N]_m[3]_b[k]) of the mode-three signal between the AiM and the RFIC respectively via the plurality of path-two terminals, and to disable signal exchange between the AiM and the RFIC via the plurality of path-four terminals.

In an embodiment (e.g., FIG. 4), the plurality of port-one terminals (e.g., V[1] to V[N]) may be arranged to respectively connect a plurality of path-three terminals (e.g., p3[1] to p3[N] in FIG. 4) of a radiofrequency integrated circuit (RFIC, e.g., 30), and the plurality of port-two terminals (e.g., H[1] to H[N]) may be arranged to respectively connect a plurality of path-four terminals (e.g., p4[1] to p4[N] in FIG. 4) of the RFIC. When the AiM implements the mode-one wireless communication, the plurality of port-one terminals may be further arranged to enable exchange of the plurality of phase-shifted versions of the mode-one signal between the AiM and the RFIC via the plurality of path-three terminals. When the AiM implements the mode-two wireless communication, the plurality of port-two terminals may be further arranged to enable exchange of the plurality of phase-shifted versions of the mode-two signal between the AiM and the RFIC via the plurality of path-four terminals. When the AiM implements the mode-three wireless communication, the plurality of port-one terminals may be further arranged to enable exchange of the first plurality of phase-shifted versions of the mode-three signal between the AiM and the RFIC via the plurality of path-three terminals, and the plurality of port-two terminals may be further arranged to enable exchange of the second plurality of phase-shifted versions of the mode-three signal between the AiM and the RFIC via the plurality of path-four terminals.

An object of the invention is providing a method (e.g., 500 in FIG. 5) for improving performances of an antenna-in-module (AiM) (e.g., 100 in FIG. 1a) in a user equipment (UE, e.g., 10 in FIG. 1c). The AiM may comprise a plurality of radiators (e.g., r[1] to r[N]) and a first number (e.g., 2*N) of terminals (e.g., V[1] to V[N] and H[1] to H[N] in FIG. 1a or 1b), and may be configured for implementing a second number (e.g., Q in FIG. 6) of communication modes (e.g., m[1] to m[Q]). Each of the first number of terminals may be coupled to one of the plurality radiators. Polarizations of the second number of communication modes may be different. The method may be executed by the UE according to a beam book (e.g., 600 in FIG. 6). The beam book may comprise a third number (e.g., Q*K) of beam book entries (e.g., e_m[1]_b[1] to e_m[Q]_b[K] in FIG. 6). Each of the third number of beam book entries may be associated with one of a fourth number (e.g., K) of beams (e.g., b[1] to b[K]) and one of the second number of communication modes, and may record one or more phases respectively associated with one or more of the first number of terminals. The method may comprise: from the beam book, selecting (e.g., 504 in FIG. 5) one of the third number of beam book entries; causing (e.g., 506 in FIG. 5) the AiM to implement the communication mode associated with the selected beam book entry by shifting phases according to the one or more phases recorded in the selected beam book entry respectively at the associated one or more of the first number of terminals.

In an embodiment (e.g., FIG. 5), when selecting one of the third number of beam book entries, selecting from a subset (e.g., a proper subset) of the third number of beam book entries, wherein each of the subset of the third number of beam book entries may not be associated with a skippable communication mode of the second number of communication modes.

In an embodiment (e.g., FIG. 8), the plurality of radiators may distribute along an array direction (e.g., da0 in FIG. 1b), and the polarization of the skippable communication mode may be substantially perpendicular to the array direction.

In an embodiment (e.g., FIG. 8), the polarization of the skippable communication mode may be substantially parallel to the array direction.

In an embodiment (e.g., FIG. 8), the plurality of radiators may be placed on a front surface (e.g., s110 in FIG. 1b) of the AiM, and may distribute alone an array direction (e.g., da0 in FIG. 1b). The front surface of the AiM may be perpendicular to a forward direction (e.g., df0 in FIG. 1b). The UE may further comprise an internal ground plane (e.g., 850 in FIG. 8) which may be substantially perpendicular to a vertical direction (e.g., z-axis in FIG. 8). The AiM may be placed (e.g., at L1 or L2 in FIG. 8) with the forward direction substantially parallel to the vertical direction, and the polarization of the skippable communication mode may be substantially perpendicular to the array direction.

In an embodiment (e.g., FIG. 8), the AiM may be placed (e.g., at L3 or L4 in FIG. 8) with the forward direction and the array direction substantially perpendicular to the vertical direction, and the polarization of the skippable communication mode may be substantially perpendicular to the vertical direction.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1a and 1b depicted an AiM according to an embodiment of the invention;

FIG. 1c depicts a schematical diagram of the AiM and a UE in which the AiM locates, wherein the UE may comprise a radiofrequency integrated circuit (RFIC) cooperating with the AiM;

FIG. 1d conceptually depicts an embodiment of beams which the AiM may form when the AiM implements wireless communication;

FIGS. 2a to 2d depict different modes of wireless communications which the AiM may implement according to an embodiment of the invention;

FIGS. 3a to 3c depict the AiM, the RFIC and their cooperation according to an embodiment of the invention;

FIG. 4 depicts the AiM and the RFIC according to an embodiment of the invention;

FIG. 5 depicts a flowchart according to an embodiment of the invention, wherein the flowchart may involve a plurality beam book entries in a beam book;

FIG. 6 depicts the beam book according to an embodiment of the invention;

FIG. 7a to 7d depict examples of the beam book entries according to an embodiment of the invention;

FIG. 8 depicts placement examples of the AiM according to an embodiment of the invention; and

FIGS. 9a and 9b depicts, by examples, improvement of cumulative distribution function (CDF) achieved by the AiM according to an embodiment of the invention.

### DETAILED DESCRIPTION OF PREFERRED EMBODIMENTS

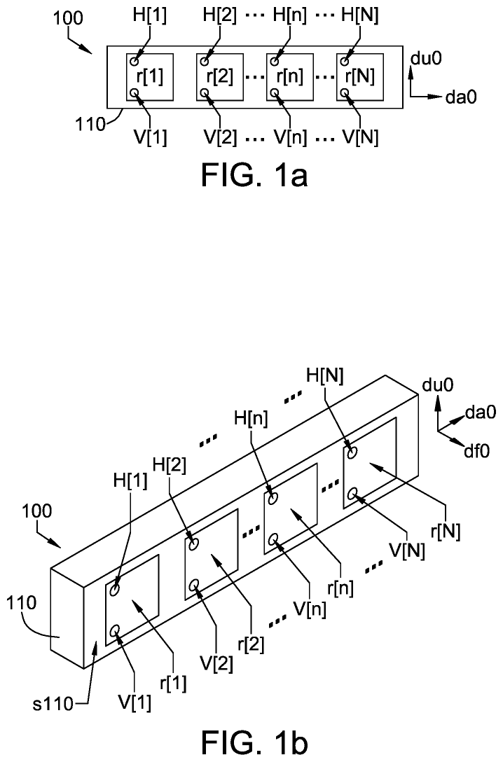

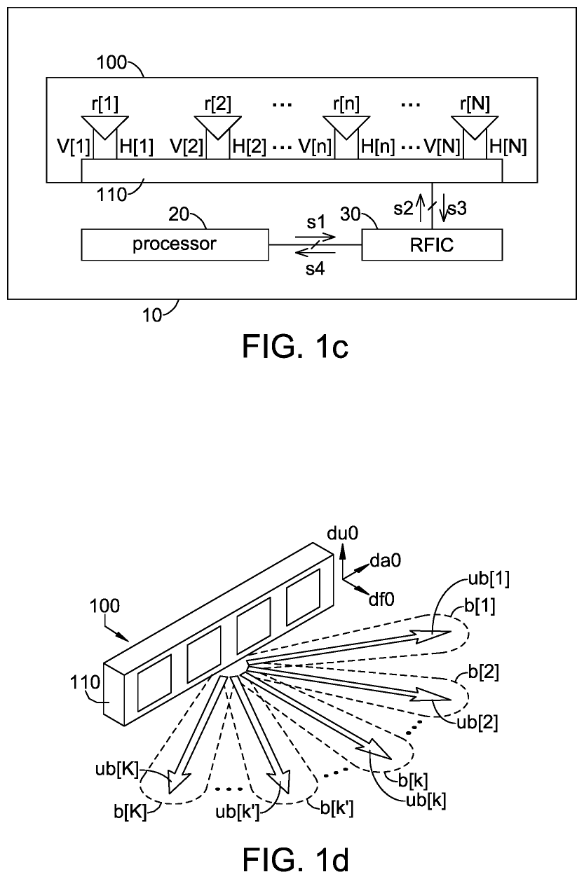

FIGS. 1a and 1 b respectively depict different views of an antenna-in-module (AiM) 100 according to an embodiment of the invention. The AiM 100 may comprise a base 110, radiators r[1] to r[N], and terminals V[1] to V[N] and H[1] to H[N], wherein the number N may be a constant integer greater than or equal to one. For example, in an embodiment, the number N may equal four. The terminals V[1] to V[N] may be port-one terminals, and may be coupled to the radiators r[1] to r[N] respectively. The terminals H[1] to H[N] may be port-two terminals, and may also be coupled to the radiators r[1] to r[N] respectively. That is, each radiator r[n] may be coupled to a port-one terminal V[n] and a port-two terminal H[n], for n=1 to N. As shown in FIG. 1b, the radiators r[1] to r[N] may be placed (e.g., be mounted or be formed) on a front surface s110 of the base 110, and may distribute alone an array direction da0 to form a linear array. In an embodiment, a distance between every two adjacent radiators (e.g., r[n] and r[n+1], for n=1 to (N−1)) may be set equal. The front surface s110 may be perpendicular to a forward direction df0; the forward direction df0 and the array direction da0 may be perpendicular to an upward direction du0.

FIG. 1c depicts a schematical diagram of the AiM 100 and a user equipment (UE) 10. The AiM 100 may be included in the UE 10 for implementing wireless communication. Besides the AiM 100, the UE 10 may further include a processor 20 and a radiofrequency integrated circuit (RFIC) 30. The processor 20 may control operations of the UE 10, and the RFIC 30 may be coupled between the processor 20 and the AiM 100. The UE 10 may be a mobile phone, a smart phone, a tablet computer, a notebook computer, a laptop computer, a desktop computer, a wearable gadget (e.g., smart watch, ear phone or glasses, etc.), a drone, a digital camera, a digital camcorder, a set-top box, a smart speaker, a game console, a customer-premises equipment (CPE), a router, an access point, a home appliance (e.g., smart TV, air conditioner, lighting system, refrigerator, washing machine, etc.), an office equipment (e.g., copy machine, printer, audio or video conference system, surveillance system, etc.), an industrial equipment (e.g., assembly line robot), an internet-of-things (IoT) sensor or device, a telematic system, a navigator, or any electronic device which needs functionality of wireless communication. The wireless communication may be, for example, mobile telecommunication adopting network access technology such as long-term evolution (LTE) and/or new radio (NR) defined by third generation partnership project (3GPP).

When the processor 20 desires to send outgoing information (e.g., message, instruction, command, data, text, photos, audio and/or video, etc.) to a remote participant (e.g., a base station, etc., not shown) by wireless communication, the processor 20 may embed the outgoing information in a signal s1, and may send the signal s1 to the RFIC 30; the RFIC 30 may form a signal s2 according to the signal s1, and may cause the radiators r[1] to r[N] of the AiM 100 to be excited according to the signal s2 via the base 110, so the radiators r[1] to r[N] may transmit radiofrequency outgoing electromagnetic waves which embeds the outgoing information. When the radiators r[1] to r[N] receive (e.g., are excited by) incoming radiofrequency electromagnetic waves, the radiators r[1] to r[N] may result in a signal s3 via the base 110, the RFIC 30 may receive the signal s3, may form a signal s4 according to the signal s3, and may send the signal s4 to the processor 10, so the processor 10 may obtain incoming information embedded in the incoming radiofrequency electromagnetic waves.

FIG. 1d conceptually depicts beams which the AiM 100 may form when the AiM 100 implements wireless communication. As the radiators r[1] to r[N] may form a radiator array, the radiators r[1] to r[N] may jointly result in a radiation pattern with a main lobe as a beam, and may steer the beam toward various directions. For example, during a number K (e.g., an integer greater than one) of different (nonoverlapping) intervals, the radiator r[1] to r[N] may form beams b[1] to b[K] pointing to different (nonparallel) beam directions ub[1] to ub[K], respectively.

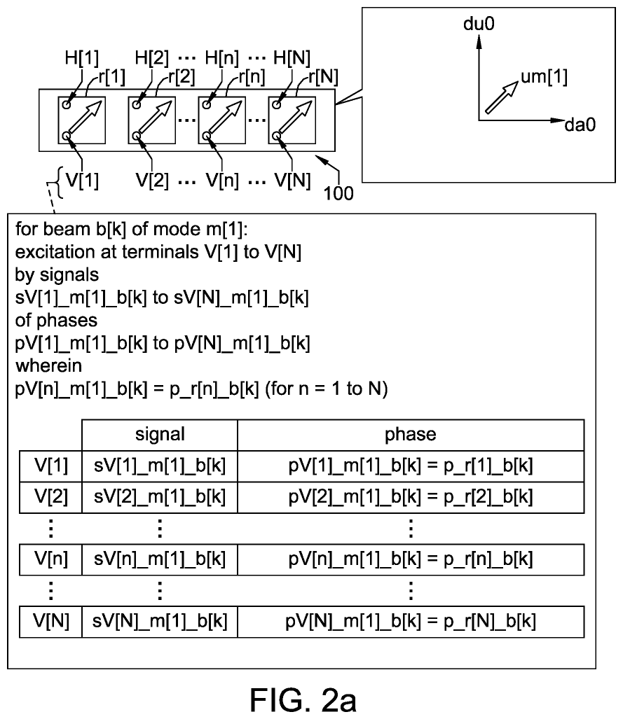

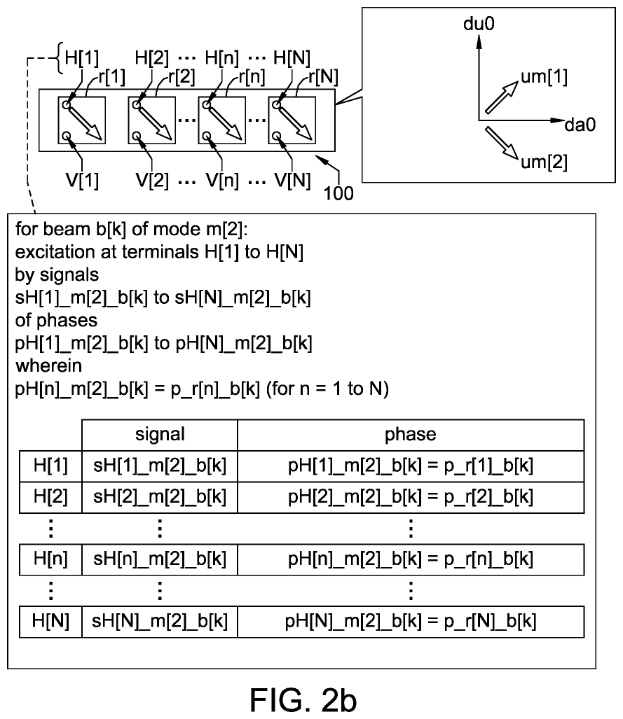

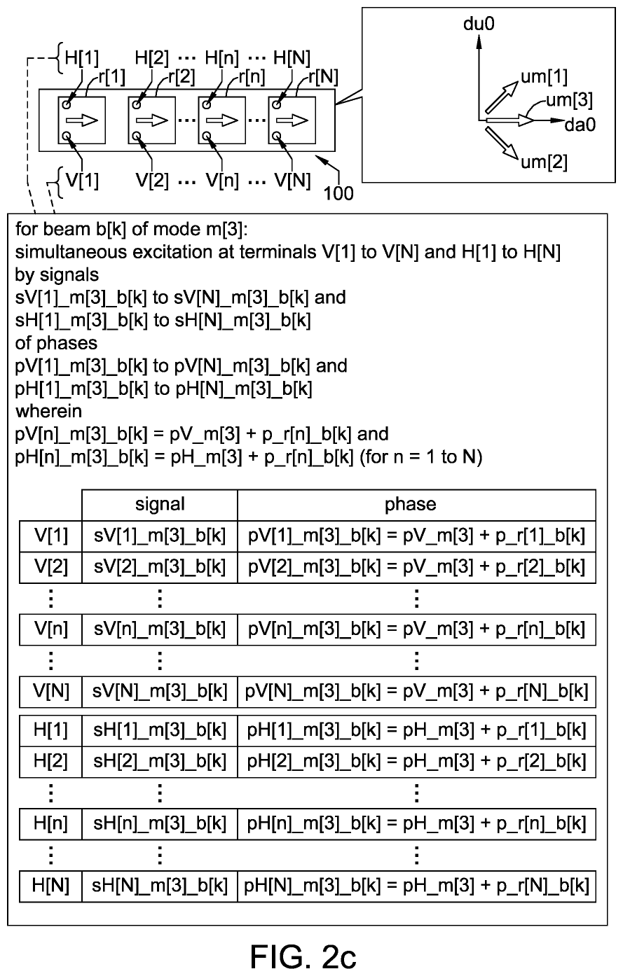

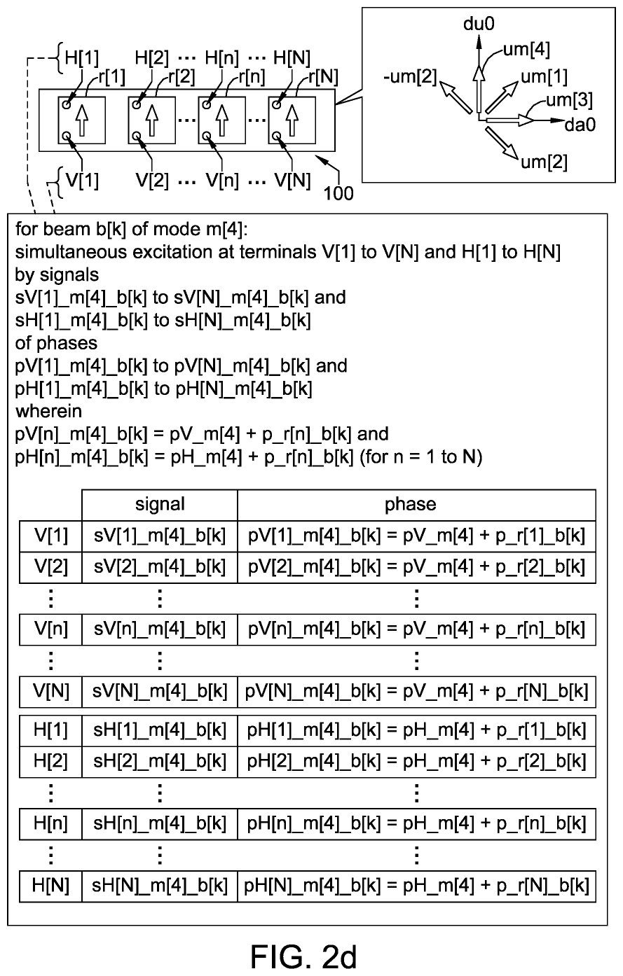

As each radiator r[n] of the AiM 100 may be coupled to two terminals V[n] and H[n], the AIM 100 may implement two different modes of wireless communications. FIG. 2a depicts how the AiM 100 may implement a mode-one (also referred to as mode m[1]) wireless communication. The AiM 100 may implement the beam b[k] (for k=1 to K, FIG. 1d) of the mode-one (m[1]) wireless communication by excitations of signals sV[1]_m[1]_b[k] to sV[N]_m[1]_b[k] respectively at the port-one terminals V[1] to V[N], wherein the signals sV[1]_m[1]_b[k] to sV[N]_m[1]_b[k] may be phase-shifted versions of a common signal, such as the signal s2 or s3 in FIG. 1c. For example, each signal sV[n]_m[1]_b[k] may result from shifting phase of the common signal by a phase pV[n]_m[1]_b[k], for n=1 to N. As shown in FIG. 2a, the phase pV[n]_m[1]_b[k] may be set equal to a phase value p_r[n]_b[k].

In an embodiment, when the AiM 100 implements the beam b[k] of the mode-one (m[1]) wireless communication, the two phase values p_r[n]_b[k] and p_r[n′]_b[k], which are respectively for two phases pV[n]_m[1]_b[k] and pV[n′]_m[1]_b[k] of two signals sV[n]_m[1]_b[k] and sV[n′]_m[1]_b[k] at two port-one terminals V[n] and V[n′] of two different radiators r[n] and r[n′], may be substantially different. In an embodiment, when the AiM 100 implements two different beams b[k] and b[k′] of the mode-one (m[1]) wireless communication respectively during two different intervals, the two phase values p_r[n]_b[k] and p_r[n]_b[k′], which are respectively for two phases pV[n]_m[1]_b[k] and pV[n]_m[1]_b[k′] of two signals sV[n]_m[1]_b[k] and sV[n]_m[1]_b[k′] at the same port-one terminals V[n] of the radiator r[n] during implementations of the beams b[k] and b[k′], may be substantially different.

In an embodiment, polarization of the mode-one (m[1]) wireless communication may be linear, and may be parallel to a mode-one vector um[1]; for example, as shown in FIG. 2a, the vector um[1] may have a vector component along the array direction da0, and a vector component along the upward direction du0.

FIG. 2b depicts how the AiM 100 may implement a mode-two (also referred to as mode m[2]) wireless communication. The AiM 100 may implement the beam b[k] (for k=1 to K, FIG. 1d) of the mode-two (m[2]) wireless communication by excitations of signals sH[1]_m[2]_b[k] to sH[N]_m[2]_b[k] respectively at the port-two terminals H[1] to H[N], wherein the signals sH[1]_m[2]_b[k] to sH[N]_m[2]_b[k] may be phase-shifted versions of a common signal, such as the signal s2 or s3 in FIG. 1c. For example, each signal sH[n]_m[2]_b[k] may result from shifting phase of the common signal by a phase pH[n]_m[2]_b[k], for n=1 to N. As shown in FIG. 2b, in an embodiment, the phase pH[n]_m[2]_b[k] may be set equal to the phase value p_r[n]_b[k] which is also utilized as the phase pV[n]_m[1]_b[k] (FIG. 2a). That is, when the AiM 100 implements the beam b[k] of the mode-one (m[1]) wireless communication (FIG. 2a) and the beam b[k] of the mode-two (m[2]) wireless communication (FIG. 2b), the phase pV[n]_m[1]_b[k] of the signal sV[n]_m[1]_b[k] at the port-one terminal V[n] of the radiator r[n] (FIG. 2a), and the phase pH[n]_m[2]_b[k] of the signal sH[n]_m[2]_b[k] at the port-two terminal H[n] of the radiator r[n] (FIG. 2b), may be substantially equal.

In an embodiment, polarization of the mode-two (m[2]) wireless communication may be linear, and may be parallel to a mode-two vector um[2]; for example, as shown in FIG. 2b, the vector um[2] may have a vector component along the array direction da0, and a vector component along an opposite of the upward direction du0. In other words, polarizations of the mode-one (m[1]) wireless communication and the mode-two (m[2]) wireless communication may be different, e.g., in direction of polarization.

According to a conventional art, the processor 20 (FIG. 1c) of the UE may cause the AiM 100 to implement each of the beams b[1] to b[K] of the mode-one (m[1]) wireless communication and each of the beams b[1] to b[K] of the mode-two (m[2]) wireless communication for transmitting and/or receiving predefined reference signals during 2*K different intervals, and may measure 2*K signal qualities during the 2*K intervals. By comparing the 2*K signal qualities, the processor 20 may find one beam of one mode which yields the best signal quality, and may adopt the found beam of the found mode for subsequent wireless communication.

On the other hand, according to the invention, the AiM 100 may further implement one or more additional modes of wireless communications besides the mode-one and mode-two wireless communications, and may therefore improve radiation performance(s) since the AiM 100 may provide more beams of more modes to be searched for best signal quality.

FIG. 2c depicts how the AiM 100 may implement a mode-three (also referred to as mode m[3]) wireless communication according to an embodiment of the invention, and FIG. 2d depicts how the AiM 100 may implement a mode-four (also referred to as mode m[4]) wireless communication according to an embodiment of the invention. As shown in FIGS. 2c and 2d, the AiM 100 may implement the beam b[k] of the mode m[q] (for k=1 to K, q=3 or 4) by simultaneous excitations of signals sV[1]_m[q]_b[k] to sV[N]_m[q]_b[k] and sH[1]_m[q]_b[k] to sH[N]_m[q]_b[k] respectively at the port-one and port-two terminals V[1] to V[N] and H[1] to H[N], wherein the signals sV[1]_m[q]_b[k] to sV[N]_m[q]_b[k] and sH[1]_m[q]_b[k] to sH[N]_m[q]_b[k] may be phase-shifted versions of a common signal, such as the signal s2 or s3 in FIG. 1c. For example, each signal sV[n]_m[q]_b[k] may result from shifting phase of the common signal by a phase pV[n]_m[q]_b[k], and each signal sH[n]_m[q]_b[k] may result from shifting phase of the common signal by a phase pH[n]_m[q]_b[k], for n=1 to N. As shown in FIGS. 2c and 2d, in an embodiment, the phase pV[n]_m[q]_b[k] may be set equal to a sum of a phase value pV_m[q] and the phase value p_r[n]_b[k], and the phase pH[n]_m[q]_b[k] may be set equal to a sum of a phase value pH_m[q] and the phase value p_r[n]_b[k].

In other words, as shown in FIG. 2c, when the AiM 100 implements the beam b[k] (for k=1 to K) of the mode-three (m[3]) wireless communication, each radiator r[n] (for n=1 to N) may contribute to the beam b[k] of the mode-three (m[3]) wireless communication by simultaneous excitations of the signals sV[n]_m[3]_b[k]] and sH[n]_m[3]_b[k] respectively at the port-one and port-two terminals V[n] and H[n] of the radiator r[n], wherein the phases pV[n]_m[3]_b[k] and pH[n]_m[3]_b[k] of the signals sV[n]_m[3]_b[k] and sH[n]_m[3]_b[k] may respectively equal (pV_m[3]+p_r[n]_b[k]) and (pH_m[3]+p_r[n]_b[k]). Similarly, as shown in FIG. 2d, when the AiM 100 implements the beam b[k](for k=1 to K) of the mode-four (m[4]) wireless communication, each radiator r[n] (for n=1 to N) may contribute to the beam b[k] of the mode-four (m[4]) wireless communication by simultaneous excitations of the signals sV[n]_m[4]_b[k]] and sH[n]_m[4]_b[k] respectively at the port-one and port-two terminals V[n] and H[n] of the radiator r[n], wherein the phases pV[n]_m[4]_b[k] and pH[n]_m[4]_b[k] of the signals sV[n]_m[4]_b[k] and sH[n]_m[4]_b[k] may respectively equal phase values (pV_m[4]+p_r[n]_b[k]) and (pH_m[4]+p_r[n]_b[k]).

According to the embodiment shown in FIG. 2c or 2d, when the AiM 100 implements two different beams b[k] and b[k′] of the same mode m[q] respectively during two different intervals (for k and k′ being different two of 1 to K, q=3 or 4), a phase difference (pV[n]_m[q]_b[k]-pH[n]_m[q]_b[k]) between the phases pV[n]_m[q]_b[k] and pH[n]_m[q]_b[k] of the signals sV[n]_m[q]_b[k] and sH[n]_m[q]_b[k] respectively at the port-one and port-two terminals V[n] and H[n] of the radiator r[n], and a phase difference (pV[n]_m[q]_b[k′]-pH[n]_m[q]_b[k′]) between the phases pV[n]_m[q]_b[k′] and pH[n]_m[q]_b[k′] of the signals sV[n]_m[q]_b[k′] and sH[n]_m[q]_b[k′] respectively at the port-one and port-two terminals V[n] and H[n] of the radiator r[n], may be substantially equal (for n=1 to N), since both the phase differences (pV[n]_m[q]_b[k]-pH[n]_m[q]_b[k]) and (pV[n]_m[q]_b[k′]-pH[n]_m[q]_b[k′]) may substantially equal a phase difference (pV_m[q]-pH_m[q]), which may substantially equal zero (for q=3) or one hundred and eighty degrees (for q=4) according to an embodiment of the invention. Briefly speaking, the phase difference between the two signals at the two different terminals V[n] and H[n] of the same radiator r[n] may be kept constant even when the AiM 100 implements different beams b[k] and b[k′] of the same mode (m[3] or m[4]) respectively during different intervals.

According to the embodiment shown in FIG. 2c or 2d, when the AiM 100 implements the beam b[k] of the mode m[q] (for k=1 to K, q=3 or 4), a phase difference (pV[n]_m[q]_b[k]-pH[n]_m[q]_b[k]) between the phases pV[n]_m[q]_b[k] and pH[n]_m[q]_b[k] of the signals sV[n]_m[q]_b[k] and sH[n]_m[q]_b[k] at the terminals V[n] and H[n] of the radiator r[n], and a phase difference (pV[n′]_m[q]_b[k]-pH[n′]_m[q]_b[k]) between the phases pV[n′]_m[q]_b[k] and pH[n′]_m[q]_b[k] of the signal sV[n′]_m[q]_b[k] and sH[n′]_m[q]_b[k] at the terminals V[n′] and H[n′] of another radiator r[n′], may be substantially equal (for n and n′ being different two of 1 to N), since both the phase differences (pV[n]_m[q]_b[k]-pH[n]_m[q]_b[k]) and (pV[n′]_m[q]_b[k]-pH[n′]_m[q]_b[k]) may substantially equal the phase difference (pV_m[q]-pH_m[q]. Briefly speaking, when the AiM 100 implements the beam b[k] of the mode-three (m[3]) or mode-four (m[4]) wireless communication, the phase difference between the two signals at the two terminals of the same radiator may be kept constant even for different radiators.

According to the embodiment shown in FIG. 2c or 2d, when the AiM 100 implements the beam b[k] of the mode m[q] (for k=1 to K, q=3 or 4), a phase difference (pV[n]_m[q]_b[k]-pV[n′]_m[q]_b[k]) between the phases pV[n]_m[q]_b[k] and pV[n′]_m[q]_b[k] of the signals sV[n]_m[q]_b[k] and sV[n′]_m[q]_b[k] respectively at the port-one terminals V[n] and V[n′] of two different radiators r[n] and r[n′], and a phase difference (pH[n]_m[q]_b[k]-pH[n′]_m[q]_b[k]) between the phases pH[n]_m[q]_b[k] and pH[n′]_m[q]_b[k] of the signal sH[n]_m[q]_b[k] and sH[n′]_m[q]_b[k] respectively at the port-two terminals H[n] and H[n′] of the two radiators r[n] and r[n′], may be substantially equal (for n and n′ being different two of 1 to N), since both the phase differences (pV[n]_m[q]_b[k]-pV[n′]_m[q]_b[k]) and (pH[n]_m[q]_b[k]-pH[n′]_m[q]_b[k]) may substantially equal a phase difference (p_r[n]_b[k]-p_r[n′]_b[k]) between the phase values p_r[n]_b[k] and p_r[n′]_b[k]. Briefly speaking, when the AiM 100 implements the beam b[k] of the mode-three (m[3]) or mode-four (m[4]) wireless communication, the phase difference between the two signals at two port-one terminals of two different radiators may substantially equal the phase difference between the two signals at the two port-two terminals of the two different radiators.

According to the embodiments shown in FIGS. 2c and 2d, when the AiM 100 implements the beam b[k] of the mode-three (m[3]) wireless communication and the beam b[k] of the mode-four (m[4]) wireless communication respectively during two different intervals (for k=1 to K), a phase difference (pV[n]_m[3]_b[k]-pH[n]_m[3]_b[k]) between the phases pV[n]_m[3]_b[k] and pH[n]_m[3]_b[k] of the signals sV[n]_m[3]_b[k] and sH[n]_m[3]_b[k] respectively at the terminals V[n] and H[n] of the radiator r[n], and a phase difference (pV[n]_m[4]_b[k]-pH[n]_m[4]_b[k]) between the phases pV[n]_m[4]_b[k] and pH[n]_m[4]_b[k] of the signals sV[n]_m[4]_b[k] and sH[n]_m[4]_b[k] respectively at the terminals V[n] and H[n] of the radiator r[n], may be substantially different (for n=1 to N), e.g., may be different by one-hundred and eighty (180) degrees substantially. Briefly speaking, the phase difference between the two signals at the port-one and port-two terminals of a radiator when the AiM 100 implement the beam b[k] of the mode-three wireless communication, and the phase difference between the two signals at the port-one and port-two terminals of the same radiator when the AiM 100 implement the same beam b[k] of the mode-four wireless communication, may be substantially different.

According to the embodiments shown in FIGS. 2c and 2d, when the AiM 100 implements the beam b[k] of the mode-three (m[3]) wireless communication and the beam b[k] of the mode-four (m[4]) wireless communication respectively during two different intervals (for k=1 to K), a phase difference (pV[n]_m[3]_b[k]-pV[n′]_m[3]_b[k]) between the phases pV[n]_m[3]_b[k] and pV[n′]_m[3]_b[k] of the signals sV[n]_m[3]_b[k] and sV[n′]_m[3]_b[k] respectively at the terminals V[n] and V[n′] of two different radiators r[n] and r[n′], and a phase difference (pV[n]_m[4]_b[k]-pV[n′]_m[4]_b[k]) between the phases pV[n]_m[4]_b[k] and pV[n′]_m[4]_b[k] of the signals sV[n]_m[4]_b[k] and sV[n′]_m[4]_b[k] respectively at the terminals V[n] and V[n′] of the two different radiators r[n] and r[n′], may be substantially equal (for n and n′ being different two of 1 to N), since both the phase differences (pV[n]_m[3]_b[k]-pV[n′]_m[3]_b[k]) and (pV[n]_m[4]_b[k]-pV[n′]_m[4]_b[k]) may substantially equal the phase difference (p_r[n]_b[k]-p_r[n′]_b[k]) between the phase values p_r[n]_b[k] and p_r[n′]_b[k]. Briefly speaking, the phase difference between the two signals at the port-one terminals of two different radiators when the AiM 100 implement the beam b[k] of the mode-three wireless communication, and the phase difference between the two signals at the port-one terminals of the two different radiators when the AiM 100 implement the same beam b[k] of the mode-four wireless communication, may be substantially equal.

According to the embodiments shown in FIGS. 2c and 2d, when the AiM 100 implements the beam b[k] of the mode-three (m[3]) wireless communication and the beam b[k] of the mode-four (m[4]) wireless communication respectively during two different intervals (for k=1 to K), a phase difference (pH[n]_m[3]_b[k]-pH[n′]_m[3]_b[k]) between the phases pH[n]_m[3]_b[k] and pH[n′]_m[3]_b[k] of the signals sH[n]_m[3]_b[k] and sH[n′]_m[3]_b[k] respectively at the terminals H[n] and H[n′] of two different radiators r[n] and r[n′], and a phase difference (pH[n]_m[4]_b[k]-pH[n′]_m[4]_b[k]) between the phases pH[n]_m[4]_b[k] and pH[n′]_m[4]_b[k] of the signals sH[n]_m[4]_b[k] and sH[n′]_m[4]_b[k] respectively at the terminals H[n] and H[n′] of the two different radiators r[n] and r[n′], may be substantially equal (for n and n′ being different two of 1 to N), since both the phase differences (pH[n]_m[3]_b[k]-pH[n′]_m[3]_b[k]) and (pH[n]_m[4]_b[k]-pH[n′]_m[4]_b[k]) may substantially equal the phase difference (p_r[n]_b[k]-p_r[n′]_b[k]) between the phase values p_r[n]_b[k] and p_r[n′]_b[k]. Briefly speaking, the phase difference between the two signals at the port-two terminals of two different radiators when the AiM 100 implement the beam b[k] of the mode-three wireless communication, and the phase difference between the two signals at the port-two terminals of the two different radiators when the AiM 100 implement the same beam b[k] of the mode-four wireless communication, may be substantially equal.

As shown in FIG. 2c, polarization of the mode-three (m[3]) wireless communication may be linear, and may be parallel to a mode-three vector um[3]. As shown in FIG. 2d, polarization of the mode-four (m[4]) wireless communication may be linear, and may be parallel to a mode-four vector um[4]. In an embodiment, the mode-one, mode-two, mode-three and the mode-four vectors um[1], um[2], um[3] and um[4] may be substantially nonparallel. That is, polarizations of the mode-one (m[1]) wireless communication, the mode-two (m[2]) wireless communication, the mode-three (m[3]) wireless communication and the mode-four (m[4]) wireless communication may be different, e.g., in direction of polarization. As shown in FIG. 2c, in an embodiment, the mode-three vector um[3] may not be perpendicular to the mode-one vector um[1] and the mode-two vector um[2], may be substantially parallel to the array direction da0, and/or may be substantially parallel to a vector sum (um[1]+um[2]) of the mode-one and mode-two vectors um[1] and um[2]. As shown in FIG. 2d, in an embodiment, the mode-four vector um[4] may not be perpendicular to the mode-one vector um[1] and the mode-two vector um[2], may be substantially parallel to the upward direction du0, and/or may be substantially parallel to a vector difference (um[1]-um[2]) between the mode-one and mode-two vectors um[1] and um[2].

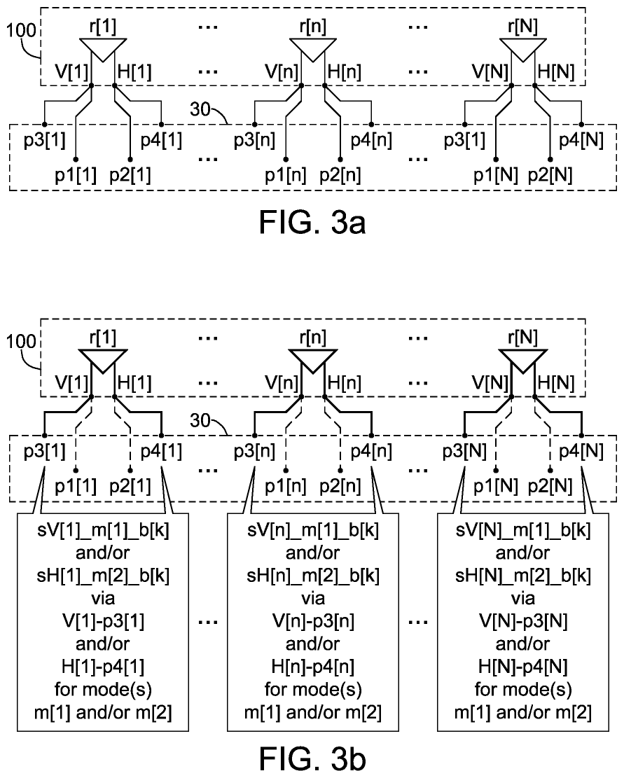

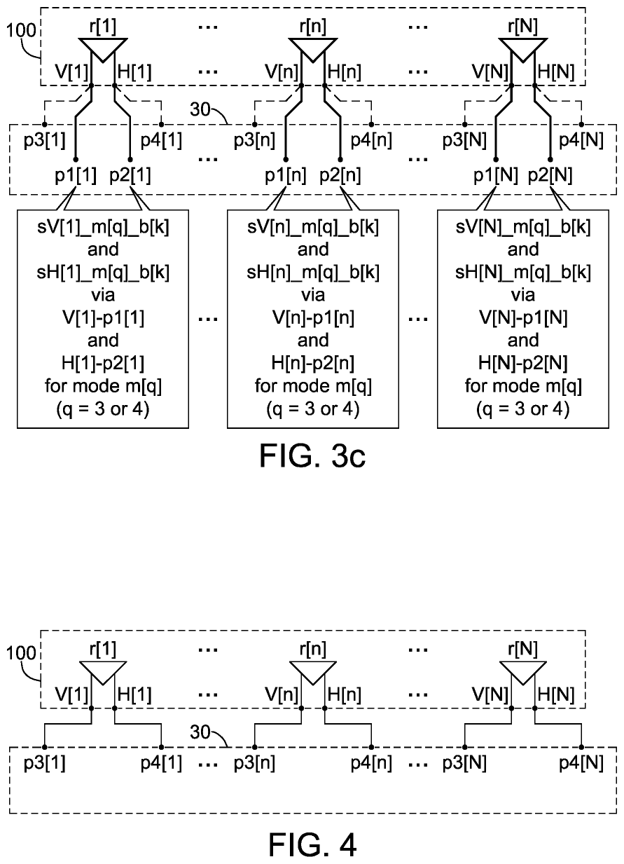

FIG. 3a conceptually depicts connections between the AiM 100 and the RFIC 30 (FIG. 1c) according to an embodiment of the invention, FIG. 3b conceptually depict cooperation of the AiM 100 and the RFIC 30 when the AiM 100 implements the mode-one (m[1]) and/or mode-two (m[2]) wireless communications according to an embodiment of the invention, and FIG. 3c conceptually depict cooperation of the AiM 100 and the RFIC 30 when the AiM 100 implements the mode-three (m[3]) or mode-four (m[4]) wireless communications according to an embodiment of the invention. As shown in FIG. 3a, the RFIC 30 may comprise path-one terminals p1[1] to p1[N], path-two terminals p2[1] to p2[N], path-three terminals p3[1] to p3[N] and path-four terminals p4[1] to p4[N]. The port-one terminals V[1] to V[N] of the AiM 100 may be arranged to respectively connect the path-one terminals p1[1] to p1 [N] of the RFIC 30, and may be further arranged to respectively connect the path-three terminals p3[1] to p3[N] of the RFIC 30; the port-two terminals H[1] to H[N] of the AiM 100 may be arranged to respectively connect the path-two terminals p2[1] to p2[N] of the RFIC 30, and may be further arranged to respectively connect the path-four terminals p4[1] to p4[N] of the RFIC 30. That is, the port-one terminal V[n] of each radiator r[n] may connect the path-one and path-three terminals p1[n] and p3[n] of the RFIC 30, and the port-two terminal H[n] of each radiator r[n] may connect the path-two and path-four terminals p2[n] and p4[n] of the RFIC 30, for n=1 to N.

As shown in FIG. 3b, when the AiM implements the beam b[k] of the mode-one (m[1]) wireless communication (for k=1 to K), the port-one terminals V[1] to V[N] of the AiM 100 may be further arranged to enable exchange of the signals sV[1]_m[1]_b[k] to sV[N]_m[1]_b[k] (FIG. 2a) between the AiM 100 and the RFIC 30 respectively via the path-three terminals p3[1] to p3[N] of the RFIC 30, and to disable signal exchange between the AiM 100 and the RFIC 30 via the path-one terminals p1[1] to p1[N] of the RFIC 30. For example, to disable signal exchange between via the path-one terminals p1[1] to p1[N], the path-one terminals p1[1] to p1[N] may switch to be electromagnetically short or open, and may be configured to follow virtual open rule.

As shown in FIG. 3b, when the AiM implements the beam b[k] of the mode-two (m[2]) wireless communication (for k=1 to K), the port-two terminals H[1] to H[N] of the AiM 100 may be further arranged to enable exchange of the signals sH[1]_m[2]_b[k] to sH[N]_m[2]_b[k] (FIG. 2b) between the AiM 100 and the RFIC 30 respectively via the path-four terminals p4[1] to p4[N] of the RFIC 30, and to disable signal exchange between the AiM 100 and the RFIC 30 via the path-two terminals p2[1] to p2[N] of the RFIC 30. For example, to disable signal exchange between via the path-two terminals p2[1] to p2[N], the path-two terminals p2[1] to p2[N] may switch to be electromagnetically short or open, and may be configured to follow virtual open rule.

As shown in FIG. 3c, when the AiM 100 implements the beam b[k] of the mode m[q] wireless communication (for k=1 to K, q=3 or 4), the port-one terminals V[1] to V[N] of the AiM 100 may be further arranged to enable exchange of the signals sV[1]_m[q]_b[k] to sV[N]_m[q]_b[k] (FIG. 2c or 2d) between the AiM 100 and the RFIC 30 respectively via the path-one terminals p1 [1] to p1[N] of the RFIC 30, and to disable signal exchange between the AiM 100 and the RFIC 30 via the path-three terminals p3[1] to p3[N] of the RFIC 30; in addition, the port-two terminals H[1] to H[N] of the AiM 100 may be further arranged to enable exchange of the signals sH[1]_m[q]_b[k] to sH[N]_m[q]_b[k] between the AiM 100 and the RFIC 30 respectively via the path-two terminals p2[1] to p2[N] of the RFIC 30, and to disable signal exchange between the AiM 100 and the RFIC 30 via the path-four terminals p4[1] to p4[N] of the RFIC 30. For example, to disable signal exchange via the path-three and path-four terminals p3[1] to p3[N] and p4[1] to p4[N], the path-three and path-four terminals p3[1] to p3[N] and p4[1] to p4[N] may switch to be electromagnetically short or open, and may be configured to follow virtual open rule.

FIG. 4 conceptually depicts connections between the AiM 100 and the RFIC 30 (FIG. 1c) according to an embodiment of the invention. As shown in FIG. 4, the RFIC 30 may comprise path-three terminals p3[1] to p3[N] and path-four terminals p4[1] to p4[N]. The port-one terminals V[1] to V[N] of the AiM 100 may be arranged to respectively connect the path-three terminals p3[1] to p3[N] of the RFIC 30, and the port-two terminals H[1] to H[N] of the AiM 100 may be arranged to respectively connect the path-four terminals p4[1] to p4[N] of the RFIC 30. When the AiM 100 implements the beam b[k] of the mode-one (m[1]) wireless communication (for k=1 to K), the port-one terminals V[1] to V[N] may be further arranged to enable exchange of the signals sV[1]_m[1]_b[k] to sV[N]_m[1]_b[k] (FIG. 2a) between the AiM 100 and the RFIC 30 respectively via the path-three terminals p3[1] to p3[N]. When the AiM implements the beam b[k] of the mode-two (m[2]) wireless communication (for k=1 to K), the port-two terminals H[1] to H[N] may be further arranged to enable exchange of the signals sH[1]_m[2]_b[k] to sH[N]_m[2]_b[k] between the AiM 100 and the RFIC 30 respectively via the path-four terminals p4[1] to p4[N].

When the AiM 100 implements the beam b[k] of the mode m[q] wireless communication (for k=1 to K, q=3 or 4), the port-one terminals V[1] to V[N] may be further arranged to enable exchange of the signals sV[1]_m[q]_b[k] to sV[N]_m[q]_b[k] between the AiM 100 and the RFIC 30 respectively via the path-three terminals p3[1] to p3[N] of the RFIC 30, and the port-two terminals H[1] to H[N] may be further arranged to enable exchange of the signals sH[1]_m[q]_b[k] to sH[N]_m[q]_b[k] between the AiM 100 and the RFIC 30 respectively via the path-four terminals p4[1] to p4[N].

The AiM 100 may implement the mode-one (m[1]) wireless communication and the mode-two (m[2]) wireless communication independently; that is, a mode-one interval (not shown) during which the AiM 100 implements the mode-one (m[1]) wireless communication may partially or completely overlap, or may not overlap, a mode-two interval (not shown) during which the AiM 100 implements the mode-two (m[2]) wireless communication. For example, the mode-one interval may start before, when or after the mode-two interval starts or ends, and may end before, when or after the mode-two interval starts or ends. On the other hand, a mode-three interval (not shown) during which the AiM 100 implements the mode-three (m[3]) wireless communication, and a mode-four interval (not shown) during which the AiM 100 implements the mode-four (m[4]) wireless communication, may not overlap. The mode-one, mode-three and mode-four intervals may not overlap, and the mode-two, mode-three and mode-four intervals may not overlap.

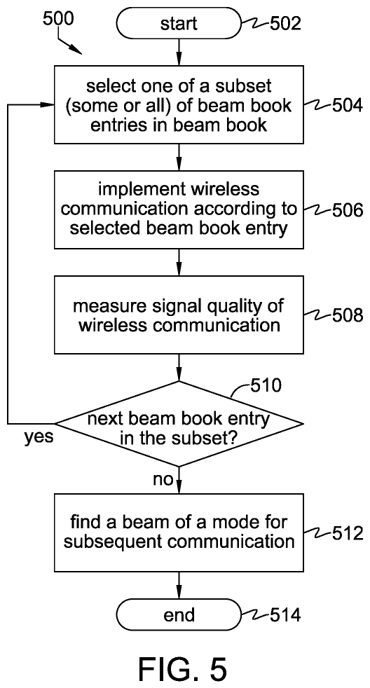

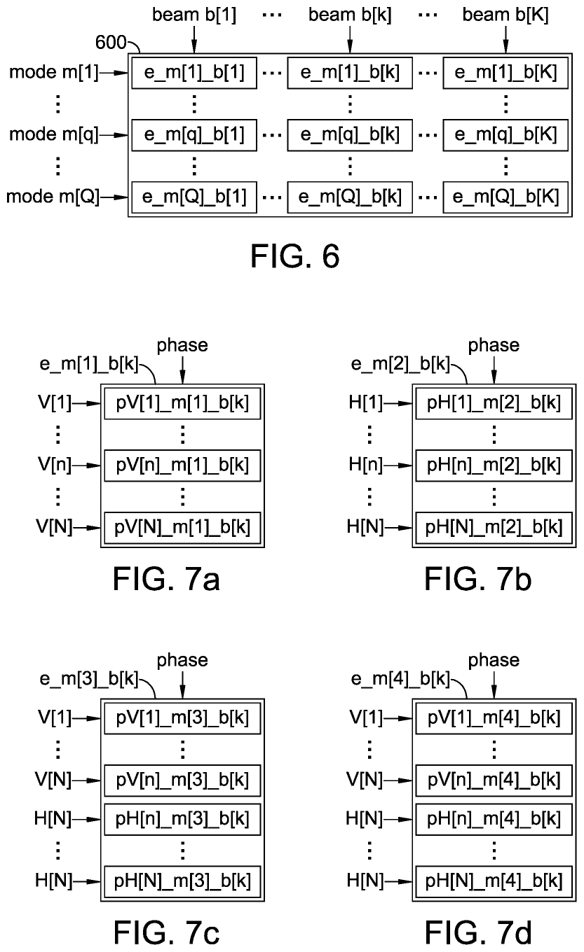

FIG. 5 depicts a flowchart 500 according to an embodiment of the invention The flowchart 500 may be executed by the processor 20 (FIG. 1c) of the UE 10 according to a beam book 600 depicted in FIG. 6. As shown in FIG. 6, the beam book 600 may comprise Q*K beam book entries e_m[1]_b[1] to e_m[1]_b[K], . . . , e_m[q]_b[1] to e_m[q]_b[K], . . . , and e_m[Q]_b[1] to e_m[Q]_b[K], wherein the number Q may represent how may modes of wireless communications the AiM 100 may implement, and may equal four in an embodiment since the AiM 100 according to the invention may implement wireless communications of modes m[1] to m[4]. Each beam book entry e_m[q]_b[k] (for q=1 to Q and k=1 to K) may be associated with the beam b[k] of the mode m[q] wireless communication, and may record phases respectively associated with one or more of the port-one and port-two terminals V[1] to V[N] and H[1] to H[N] of the AiM 100. FIGS. 7a to 7d respectively depict beam book entries e_m[1]_b[k] to e_m[4]_b[k] according to an embodiment of the invention.

As shown in FIG. 7a, the beam book entry e_m[1]_b[k] may be associated with the beam b[k] of the mode-one (m[1]) wireless communication, and may record the phases pV[1]_m[1]_b[k] to pV[N]_m[1]_b[k] (FIG. 2a) respectively associated with the signals sV[1]_m[1]_b[k] to sV[N]_m[1]_b[k] at the port-one terminals V[1] to V[N]. As shown In FIG. 7b, the beam book entry e_m[2]_b[k] may be associated with the beam b[k] of the mode-two (m[2]) wireless communication, and may record the phases pH[1]_m[2]_b[k] to pH[N]_m[2]_b[k] (FIG. 2b) respectively associated with the signals sH[1]_m[2]_b[k] to sH[N]_m[2]_b[k] at the port-two terminals H[1] to H[N]. As shown in FIG. 7c, the beam book entry e_m[3]_b[k] may be associated with the beam b[k] of the mode-three (m[3]) wireless communication, and may record the phases pV[1]_m[3]_b[k] to pV[N]_m[3]_b[k] and pH[1]_m[3]_b[k] to pH[N]_m[3]_b[k] (FIG. 2c) respectively associated with the signals sV[1]_m[3]_b[k] to sV[N]_m[3]_b[k] and sH[1]_m[3]_b[k] to sH[N]_m[3]_b[k] at the port-one and port two terminals V[1] to V[N] and H[1] to H[N]. As shown in FIG. 7d, the beam book entry e_m[4]_b[k] may be associated with the beam b[k] of the mode-four (m[4]) wireless communication, and may record the phases pV[1]_m[4]_b[k] to pV[N]_m[4]_b[k] and pH[1]_m[4]_b[k] to pH[N]_m[4]_b[k] (FIG. 2d) respectively associated with the signals sV[1]_m[4]_b[k] to sV[N]_m[4]_b[k] and sH[1]_m[4]_b[k] to sH[N]_m[4]_b[k] at the port-one and port two terminals V[1] to V[N] and H[1] to H[N].

Back to FIG. 5, the flowchart 500 may comprise steps describes as follows.

Step 502: the processor 20 may start the flowchart 500. For example, the processor 20 may start the flowchart when the processor 20 executes a beamforming optimization procedure or a beam management procedure, etc.

Step 504: the processor 20 may select a beam book entry e_m[q]_b[k] (for q being one of 1 to Q, k being one of 1 to K) from a subset (one, some or all) of the Q*K beam book entries e_m[1]_b[1] to e_m[Q]_b[K] in the beam book 600 (FIG. 6). In an embodiment, the subset may include all the Q*K beam book entries of the beam book 600; that is, when the processor select one of the subset of the Q*K beam book entries in the beam book 600, the processor 20 may select a beam book entry from all the Q*K beam book entries. In a different embodiment, the processor 20 may select a beam book entry from a proper subset (i.e., a reduced or smaller subset) of all the Q*K beam book entries, wherein the proper subset of all the Q*K beam book entries may exclude one or more beam book entries from all the Q*K beam book entries, and may therefore include beam book entries fewer than all the Q*K beam book entries.

According to an embodiment of the invention, each beam book entry in the proper subset of the Q*K beam book entries may not be associated with any beam of one or more skippable modes; that is, the proper subset of the Q*K beam book entries may exclude the beam book entries e_m[q′]_b[1] to e_m[q′]_b[K] associated with the beams b[1] to b[K] of the mode m[q′] wireless communication if the mode m[q′] is one of the one or more skippable modes. How to determine whether a mode is skippable will be described later.

Step 506: with a beam book entry e_m[q]_b[k] being selected at step 504, the processor 30 may cause the AiM 100 to implement the beam b[k] of the mode m[q] wireless communication associated with the selected beam book entry e_m[q]_b[k] by shifting phases according to the phases recorded in the selected beam book e_m[q]_b[k] entry respectively at the associated terminals. For example, if the beam book entry selected at step 504 is a beam book entry e_m[1]_b[k], the processor 30 may, at step 506, cause the AiM 100 to implement the beam b[k] of the mode-one (m[1]) wireless communication by shifting phases according to the phases pV[1]_m[1]_b[k] to pV[N]_m[1]_b[k] recorded in the selected beam book entry e_m[1]_b[k] to form the signals sV[1]_m[1]_b[k] to sV[N]_m[1]_b[k] respectively at the terminals V[1] to V[N]. If the beam book entry selected at step 504 is a beam book entry e_m[2]_b[k], the processor 30 may, at step 506, cause the AiM 100 to implement the beam b[k] of the mode-two (m[2]) wireless communication by shifting phases according to the phases pH[1]_m[2]_b[k] to pH[N]_m[2]_b[k] recorded in the selected beam book entry e_m[2]_b[k] to form the signals sH[1]_m[2]_b[k] to sH[N]_m[2]_b[k] respectively at the terminals H[1] to H[N]. If the beam book entry selected at step 504 is a beam book entry e_m[3]_b[k], the processor 30 may, at step 506, cause the AiM 100 to implement the beam b[k] of the mode-three (m[3]) wireless communication by shifting phases according to the phases pV[1]_m[3]_b[k] to pV[N]_m[3]_b[k] and pH[1]_m[3]_b[k] to pH[N]_m[3]_b[k] recorded in the selected beam book entry e_m[3]_b[k] to form the signals sV[1]_m[3]_b[k] to sV[N]_m[3]_b[k] and sH[1]_m[3]_b[k] to sH[N]_m[3]_b[k] respectively at the terminals V[1] to V[N] and H[1] to H[N]. Similarly, If the beam book entry selected at step 504 is a beam book entry e_m[4]_b[k], the processor 30 may, at step 506, cause the AiM 100 to implement the beam b[k] of the mode-four (m[4]) wireless communication by shifting phases according to the phases pV[1]_m[4]_b[k] to pV[N]_m[4]_b[k] and pH[1]_m[4]_b[k] to pH[N]_m[4]_b[k] recorded in the selected beam book entry e_m[4]_b[k] to form the signals sV[1]_m[4]_b[k] to sV[N]_m[4]_b[k] and sH[1]_m[4]_b[k] to sH[N]_m[4]_b[k] respectively at the terminals V[1] to V[N] and H[1] to H[N]. By implementing the beam b[k] of the mode m[q] wireless communication associated with the selected beam book entry e_m[q]_b[k], the AiM 100 may transmit and/or receive one or more predefined reference signals.

Step 508: when (or after) the AiM 100 implements the beam b[k] of the mode m[q] wireless communication associated with the selected beam book entry e_m[q]_b[k] to transmit and/or receive the one or more predefined reference signals, the processor 20 and/or the UE 10 may measure and calculate signal quality of the implemented beam b[k] of the mode m[q] wireless communication associated with the selected beam book entry e_m[q]_b[k]. The signal quality may be, may include, or may relate to, one or more of the following: reference signal received power (RSRP), reference signal received quality (RSRQ), received signal strength indicator (RSSI) and signal to interference and noise ratio (SINR), etc.

Step 510: if the subset (all or some) of the beam book entries considered at step 504 still include one or more beam book entries not selected, implemented and measured, the processor 20 may iterate back to step 504 to select one of the one or more unselected beam book entries from the subset of the beam book entries. If all the beam book entries in the subset of the beam book entries are selected, implemented and measured (at step 504, 506 and 508), the processor 20 may proceed to step 512.

Step 512: by comparing signal qualities of different beams of different modes iteratively selected, implemented and measured respectively at steps 504, 506 and 508, the processor 20 may find a best beam-mode combination which results in the best signal quality, and may adopt the found beam of the found mode for subsequent wireless communication.

Step 514: the processor 20 may end the flowchart 500. The processor 20 may repeat the flowchart 500 periodically and/or aperiodically (e.g., when a predefined event occurs), and may therefore dynamically update the best beam and the best mode.

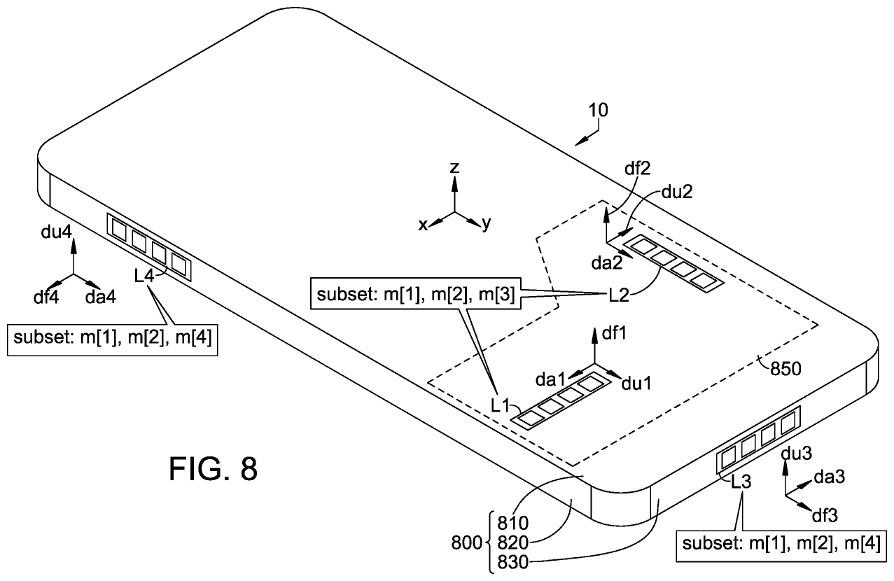

According to an embodiment of the invention, which mode is skippable at step 504 may be determined according to placement of the AiM 100. FIG. 8 depicts some (but not all) AIM placement examples according to an embodiment of the invention. As shown in FIG. 8, the UE 10 (FIG. 1c) may further comprise an internal ground plane 850 parallel to x-y plane and perpendicular to z-direction, and may be enclosed in a housing 800. The housing 800 may comprise a cover surface 810 and one or more rim surfaces such as 820 and 830, etc. A first AiM placement example is to place the AiM 100 at a location L1, with the array, upward and forward directions da0, du0 and df0 (FIG. 1b) of the AiM 100 directing along three directions da1, du1 and df1 which may be parallel to x-direction, y-direction and z-direction respectively. A second AiM placement example is to place the AiM 100 at a location L2, with the array, upward and forward directions da0, du0 and df0 of the AiM 100 directing along three directions da2, du2 and df2 which may be parallel to y-direction, negative x-direction and z-direction respectively. A third AiM placement example is to place the AiM 100 at a location L3, with the array, upward and forward directions da0, du0 and df0 of the AiM 100 directing along three directions da3, du3 and df3 which may be parallel to negative x-direction, z-direction and y-direction respectively. A fourth AiM placement example is to place the AiM 100 at a location L4, with the array, upward and forward directions da0, du0 and df0 of the AiM 100 directing along three directions da4, du4 and df4 which may be parallel to y-direction, z-direction and x-direction respectively.

According to an embodiment of the invention, if the AiM 100 is placed following the first or second AiM placement example with the forward direction df0 of the AiM 100 directing along the direction df1 or df2 parallel to the z-direction, then the mode m[4] may be the skippable mode at step 504. When the AiM 100 is placed parallel to a nearby larger metal plane such as the internal ground plane 850, polarization along a direction perpendicular to the array direction da0 may not significantly benefit radiation. Since polarization of the mode-four (m[4]) wireless communication, as demonstrated by the mode-four vector um[4] in FIG. 2d, may be substantially perpendicular to the array direction da0, the mode m[4] may be a skippable mode when the AiM 100 is placed at the location L1 or L2 following the first or second AiM placement example. That is, if the AiM 100 is placed according to the first or second AIM placement example, the proper subset of the Q*K beam book entries considered at step 504 (FIG. 5), if adopted, may exclude beam book entries e_m[4]_b[1] to e_m[4]_b[K] associated with the beams b[1] to b[K] of the mode-four (m[4]) wireless communication, and may therefore include (Q−1)*K beam book entries associated with the beams b[1] to b[K] of the mode-one, mode-two and mode-three (m[1], m[2] and m[3]) wireless communications. Execution of the flowchart 500 may therefore be simplified due to fewer ((Q−1)*K instead of Q*K) iterations of steps 504, 506 and 508.

On the other hand, according to an embodiment of the invention, if the AiM 100 is placed following the third or fourth AiM placement example with the upward direction du0 of the AiM 100 directing along the direction du3 or du4 parallel to the z-direction, then the mode m[3] may be the skippable mode at step 504. When the AiM 100 is placed on a slot opening extending along a longer edge of the rim surface 820 or 830, polarization along a direction parallel to the array direction da0 may not significantly benefit radiation. Since polarization of the mode-three (m[3]) wireless communication, as demonstrated by the mode-three vector um[3] in FIG. 2c, may be substantially parallel to the array direction da0, the mode m[3] may be a skippable mode when the AiM 100 is placed at the location L3 or L4 following the third or fourth AiM placement example. That is, if the AiM 100 is placed according to the third or fourth AiM placement example, the proper subset of the Q*K beam book entries considered at step 504, if adopted, may exclude beam book entries e_m[3]_b[1] to e_m[3]_b[K] associated with the beams b[1] to b[K] of the mode-three (m[3]) wireless communication, and may therefore include (Q−1)*K beam book entries associated with the beams b[1] to b[K] of the mode-one, mode-two and mode-four (m[1], m[2] and m[4]) wireless communications. Execution of the flowchart 500 may therefore be simplified due to fewer ((Q−1)*K instead of Q*K) iterations of steps 504, 506 and 508.

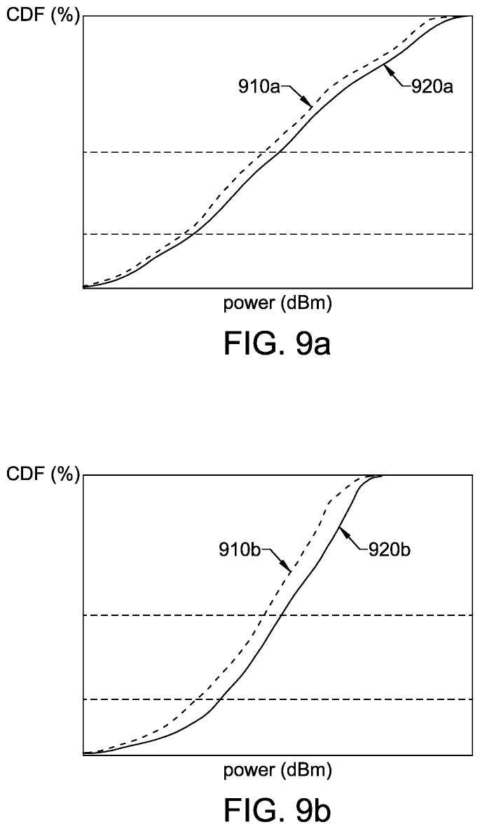

FIG. 9a depicts two curves 910a and 920a. The curve 910a may represent cumulative distribution function (CDF) of effective isotropic radiation power (EIRP) achieved by a conventional art which only adopts the mode-one and mode-two wireless communications and finds the best beam-mode combination from the 2*K beam-mode combinations implemented by the K beams of the mode-one and mode-two wireless communications, when the AiM 100 is placed at the location L1 or L2 (FIG. 8) following the first or second AiM placement example. On the other hand, the curve 920a may represent CDF of EIRP achieved by the invention, when the AiM 100 is placed at the location L1 or L2 (FIG. 8) following the first or second AiM placement example. Since CDF is more to the right the better, the curve 920a being right to the curve 910a may indicate that the CDF of the invention is improved to be better than the CDF of the conventional art. Because the invention may additionally adopt the mode-three and/or mode-four wireless communication(s) besides the mode-one and mode-two wireless communications, the invention may find the best beam-mode combination from more beam-mode combinations implemented by the K beams of at least three of the mode-one, mode-two, mode-three and mode-four wireless communications, and may then effectively improve the CDF.

FIG. 9b depicts two curves 910b and 920b. The curve 910b may represent CDF achieved by the conventional art which only adopts the mode-one and mode-two wireless communications and finds the best beam-mode combination from the 2*K beam-mode combinations implemented by the K beams of the mode-one and mode-two wireless communications, when the AiM 100 is placed at the location L3 or L4 (FIG. 8) following the third or fourth AiM placement example. On the other hand, the curve 920b may represent CDF achieved by the invention, when the AiM 100 is placed at the location L3 or L4 following the third or fourth AiM placement example. The curve 920a being right to the curve 910b may indicate that the CDF of the invention is improved to be better than the CDF of the conventional art.

To sum up, according to the invention, the AiM may implement beams of more modes of wireless communications, and may therefore provide more beam-mode combinations when finding the best beam-mode combination during beamforming optimization procedure and/or beam management procedure. Radiation performance(s), such as CDF, of the AiM may therefore be effectively improved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna-in-module (AiM) with improved performances, comprising:
a plurality of radiators;
a plurality of port-one terminals respectively coupled to the plurality of radiators; and
a plurality of port-two terminals respectively coupled to the plurality of radiators; wherein:
the AiM implements a mode-one wireless communication by excitations of a plurality of phase-shifted versions of a mode-one signal respectively at the plurality of port-one terminals;
the AiM further implements a mode-two wireless communication by excitations of a plurality of phase-shifted versions of a mode-two signal respectively at the plurality of port-two terminals;
the AiM further implements a mode-three wireless communication by simultaneous excitations of a first plurality and a second plurality of phase-shifted versions of a mode-three signal respectively at the plurality of port-one terminals and the plurality of port-two terminals; and
polarizations of the mode-one, the mode-two and the mode-three wireless communications are different.

2. The AiM of claim 1, wherein:
the polarizations of the mode-one, the mode-two and the mode-three wireless communications are parallel to a mode-one, a mode-two and a mode-three vectors, respectively; and
the mode-one, mode-two and mode-three vectors are nonparallel.

3. The AiM of claim 2, wherein:
the mode-three vector is not perpendicular to the mode-one and mode-two vectors.

4. The AiM of claim 2, wherein:
the mode-three vector is parallel to a sum of the mode-one and mode-two vectors, or a difference between the mode-one and mode-two vectors.

5. The AiM of claim 1, wherein:
a first port-one terminal of the plurality of port-one terminals is coupled to a first radiator of the plurality of radiators;
a first port-two terminal of the plurality of port-two terminals is coupled to the first radiator;
the first plurality of phase-shifted versions of the mode-three signal include a first and a fifth phase-shifted versions of the mode-three signal;
the second plurality of phase-shifted versions of the mode-three signal include a second and a sixth phase-shifted versions of the mode-three signal;
when the AiM implements the mode-three wireless communication, the first radiator contributes to a first beam of the mode-three wireless communication by simultaneous excitations of the first and the second phase-shifted versions of the mode-three signal respectively at the first port-one terminal and the first port-two terminal, and contributes to a second beam of the mode-three wireless communication by simultaneous excitations of the fifth and the sixth phase-shifted versions of the mode-three signal respectively at the first port-one terminal and the first port-two terminal;
beam directions of the first and the second beams of the mode-three wireless communication are substantially nonparallel; and
a phase difference between the first and the second phase-shifted versions of the mode-three signal, and a phase difference between the fifth and the sixth phase-shifted versions of the mode-three signal, are substantially equal.

6. The AiM of claim 1, wherein:
a first port-one terminal and a second port-one terminal of the plurality of port-one terminals are respectively coupled to a first radiator and a second radiator of the plurality of radiators;
a first port-two terminal and a second port-two terminal of the plurality of port-two terminals are respectively coupled to the first radiator and the second radiator;
the first plurality of phase-shifted versions of the mode-three signal include a first and a third phase-shifted versions of the mode-three signal;
the second plurality of phase-shifted versions of the mode-three signal include a second and a fourth phase-shifted versions of the mode-three signal;
when the AiM implements the mode-three wireless communication, the first radiator contributes to a beam of the mode-three wireless communication by simultaneous excitations of the first and the second phase-shifted versions of the mode-three signal respectively at the first port-one terminal and the first port-two terminal, and the second radiator contributes to the beam of the mode-three wireless communication by simultaneous excitations of the third and the fourth phase-shifted versions of the mode-three signal respectively at the second port-one terminal and the second port-two terminal; and
a phase difference between the first and the second phase-shifted versions of the mode-three signal, and a phase difference between the third and the fourth phase-shifted versions of the mode-three signal, are substantially equal.

7. The AiM of claim 6, wherein:
a phase difference between the first and the third phase-shifted versions of the mode-three signal, and a phase difference between the second and the fourth phase-shifted versions of the mode-three signal, are substantially equal.

8. The AiM of claim 1, wherein:
the AiM further implements a mode-four wireless communication by simultaneous excitations of a first plurality and a second plurality of phase-shifted versions of a mode-four signal respectively at the plurality of port-one terminals and the plurality of port-two terminals; and
a polarization of the mode-four wireless communication is different from the polarizations of the mode-one, the mode-two and the mode-three wireless communications.

9. The AiM of claim 8, wherein:
the polarizations of the mode-one, the mode-two, the mode-three and the mode-four wireless communications are along a mode-one, a mode-two, a mode-three and a mode-four vectors, respectively;
the mode-three vector is parallel to a sum of the mode-one and mode-two vectors; and
the mode-four vector is parallel to a difference between the mode-one and mode-two vectors.

10. The AiM of claim 8, wherein:
a first port-one terminal of the plurality of port-one terminals is coupled to a first radiator of the plurality of radiators;
a first port-two terminal of the plurality of port-two terminals is coupled to the first radiator;
the first plurality of phase-shifted versions of the mode-three signal include a first phase-shifted version of the mode-three signal;
the second plurality of phase-shifted versions of the mode-three signal include a second phase-shifted version of the mode-three signal;
the first plurality of phase-shifted versions of the mode-four signal include a first phase-shifted version of the mode-four signal;
the second plurality of phase-shifted versions of the mode-four signal include a second phase-shifted version of the mode-four signal;
when the AiM implements the mode-three wireless communication, the first radiator contributes to a beam of the mode-three wireless communication by simultaneous excitations of the first and the second phase shifted versions of the mode-three signal respectively at the first port-one terminal and the first port-two terminal;
when the AiM implements the mode-four wireless communication, the first radiator contributes to a beam of the mode-four wireless communication by simultaneous excitations of the first and the second phase shifted versions of the mode-four signal respectively at the first port-one terminal and the first port-two terminal;
a beam direction of the beam of the mode-three wireless communication, and a beam direction of the beam of the mode-four wireless communication, are substantially parallel; and
a phase difference between the first and the second phase-shifted versions of the mode-three signal, and a phase difference between the first and the second phase-shifted versions of the mode-four signal, are substantially different.

11. The AiM of claim 10, wherein:
the phase difference between the first and the second phase-shifted versions of the mode-three signal, and the phase difference between the first and the second phase-shifted versions of the mode-four signal, are substantially different by one-hundred and eighty degrees.

12. The AiM of claim 8, wherein:
a first port-one terminal and a second port-one terminal of the plurality of port-one terminals are respectively coupled to a first radiator and a second radiator of the plurality of radiators;
a first port-two terminal and a second port-two terminal of the plurality of port-two terminals are respectively coupled to the first radiator and the second radiator;
the first plurality of phase-shifted versions of the mode-three signal include a first and a third phase-shifted versions of the mode-three signal;
the second plurality of phase-shifted versions of the mode-three signal include a second and a fourth phase-shifted versions of the mode-three signal;
the first plurality of phase-shifted versions of the mode-four signal include a first and a third phase-shifted versions of the mode-four signal;
the second plurality of phase-shifted versions of the mode-four signal include a second and a fourth phase-shifted versions of the mode-four signal;
when the AiM implements the mode-three wireless communication, the first radiator contributes to a beam of the mode-three wireless communication by simultaneous excitations of the first and the second phase shifted versions of the mode-three signal respectively at the first port-one terminal and the first port-two terminals, and the second radiator contributes to the beam of the mode-three wireless communication by simultaneous excitations of the third and the fourth phase-shifted versions of the mode-three signal respectively at the second port-one and the second port-two terminals;
when the AiM implements the mode-four wireless communication, the first radiator contributes to a beam of the mode-four wireless communication by simultaneous excitations of the first and the second phase shifted versions of the mode-four signal respectively at the first port-one terminal and the first port-two terminals, and the second radiator contributes to the beam of the mode-four wireless communication by simultaneous excitations of the third and the fourth phase-shifted versions of the mode-four signal respectively at the second port-one and the second port-two terminals;
a beam direction of the beam of the mode-three wireless communication, and a beam direction of the beam of the mode-four wireless communication, are substantially parallel; and
a phase difference between the first and the third phase-shifted versions of the mode-three signal, and a phase difference between the first and the third phase-shifted versions of the mode-four signal, are substantially equal.

13. The AiM of claim 1, wherein:
the plurality of port-one terminals are arranged to respectively connect a plurality of path-one terminals of a radiofrequency integrated circuit (RFIC), and to respectively connect a plurality of path-three terminals of the RFIC;
the plurality of port-two terminals are arranged to respectively connect a plurality of path-two terminals of the RFIC, and to respectively connect a plurality of path-four terminals of the RFIC;
when the AiM implements the mode-one wireless communication, the plurality of port-one terminals are further arranged to enable exchange of the plurality of phase-shifted versions of the mode-one signal between the AiM and the RFIC respectively via the plurality of path-three terminals, and to disable signal exchange between the AiM and the RFIC via the plurality of path-one terminals;
when the AiM implements the mode-two wireless communication, the plurality of port-two terminals are further arranged to enable exchange of the plurality of phase-shifted versions of the mode-two signal between the AiM and the RFIC respectively via the plurality of path-four terminals, and to disable signal exchange between the AiM and the RFIC via the plurality of path-two terminals; and
when the AiM implements the mode-three wireless communication, the plurality of port-one terminals are further arranged to enable exchange of the first plurality of phase-shifted versions of the mode-three signal between the AiM and the RFIC respectively via the plurality of path-one terminals, and to disable signal exchange between the AiM and the RFIC via the plurality of path-three terminals; and the plurality of port-two terminals are further arranged to enable exchange of the second plurality of phase-shifted versions of the mode-three signal between the AiM and the RFIC respectively via the plurality of path-two terminals, and to disable signal exchange between the AiM and the RFIC via the plurality of path-four terminals.

14. The AiM of claim 1, wherein:
the plurality of port-one terminals are arranged to respectively connect a plurality of path-three terminals of a radiofrequency integrated circuit (RFIC);
the plurality of port-two terminals are arranged to respectively connect a plurality of path-four terminals of the RFIC;
when the AiM implements the mode-one wireless communication, the plurality of port-one terminals are further arranged to enable exchange of the plurality of phase-shifted versions of the mode-one signal between the AiM and the RFIC via the plurality of path-three terminals;
when the AiM implements the mode-two wireless communication, the plurality of port-two terminals are further arranged to enable exchange of the plurality of phase-shifted versions of the mode-two signal between the AiM and the RFIC via the plurality of path-four terminals; and
when the AiM implements the mode-three wireless communication, the plurality of port-one terminals are further arranged to enable exchange of the first plurality of phase-shifted versions of the mode-three signal between the AiM and the RFIC via the plurality of path-three terminals, and the plurality of port-two terminals are further arranged to enable exchange of the second plurality of phase-shifted versions of the mode-three signal between the AiM and the RFIC via the plurality of path-four terminals.

15. A method for improving performances of an antenna-in-module (AiM) in a user equipment (UE), wherein:
the AiM comprises a plurality of radiators and a first number of terminals, and is configured for implementing a second number of communication modes;
each of the first number of terminals is coupled to one of the plurality radiators;
polarizations of the second number of communication modes are different;
the method is executed by the UE according to a beam book;
the beam book comprises a third number of beam book entries;
each of the third number of beam book entries is associated with one of a fourth number of beams and one of the second number of communication modes, and records one or more phases respectively associated with one or more of the first number of terminals;
the method comprises:
from the beam book, selecting one of the third number of beam book entries;
causing the AiM to implement the communication mode associated with the selected beam book entry by shifting phases according to the one or more phases recorded in the selected beam book entry respectively at the associated one or more of the first number of terminals.

16. The method of claim 15, wherein:
when selecting one of the third number of beam book entries, selecting from a subset of the third number of beam book entries; and
each of the subset of the third number of beam book entries is not associated with a skippable communication mode of the second number of communication modes.

17. The method of claim 16, wherein:
the plurality of radiators distribute along an array direction; and
the polarization of the skippable communication mode is substantially perpendicular to the array direction.

18. The method of claim 16, wherein:
the plurality of radiators distribute along an array direction; and
the polarization of the skippable communication mode is substantially parallel to the array direction.

19. The method of claim 16, wherein:
the plurality of radiators are placed on a front surface of the AiM, and distribute alone an array direction;
the front surface of the AiM is perpendicular to a forward direction;
the UE further comprises an internal ground plane which is substantially perpendicular to a vertical direction;
the AiM is placed with the forward direction substantially parallel to the vertical direction; and
the polarization of the skippable communication mode is substantially perpendicular to the array direction.

20. The method of claim 16, wherein:
the plurality of radiators are placed on a front surface of the AiM, and distribute alone an array direction;
the front surface of the AiM is perpendicular to a forward direction;
the UE further comprises an internal ground plane which is substantially perpendicular to a vertical direction;
the AiM is placed with the forward direction and the array direction substantially perpendicular to the vertical direction; and
the polarization of the skippable communication mode is substantially perpendicular to the vertical direction.
